(19) United States
(12) Patent Application Publication
(10) Pub. No.: US 2010/0027255 A1
(43) Pub. Date: Feb. 4, 2010

(54) LIGHT BOX APPARATUS

(75) Inventors: CHIA CHEN CHANG, Yilan County (TW); SHIH CHIEH TSENG, Changhua County (TW); WEI HUNG WU, Kaohsiung City (TW)

Correspondence Address: WPAT, PC;INTELLECTUAL PROPERTY ATTORNEYS, 2030 MAIN STREET, SUITE 1300, IRVINE, CA, 92614, US

(73) Assignee: ADVANCED OPTOELECTRONIC TECHNOLOGY INC., HSINCHU COUNTY (TW)

(21) Appl. No.: 12/508,734

(22) Filed: Jul. 24, 2009

(30) Foreign Application Priority Data
Jul. 29, 2008 (TW) 097128573

(51) Int. Cl. F21V 1/00

(52) U.S. Cl. 362/235

(57) ABSTRACT

A light box apparatus comprises at least one light source, a frame, and a light guide plate. The frame, the side frames of which are made of metallic formed bars, has an accommodation space. The light guide plate, disposed in the accommodation space, has a lateral side. The frame has at least one side frame edge, which has an inlay groove adjacent to the lateral side, and the light, emitted from the light source disposed in the inlay groove, passes through the lateral side and transmits in the light guide plate.

### BACKGROUND OF THE INVENTION

1. Field of the Invention

The present invention relates to a planar light source, and relates more particularly to a light box apparatus for advertisement or signage.

2. Description of the Related Art

Light boxes, using a planar light source to demonstrate patterns or messages on a light transmittable plate by lighting, are a popular lighting device in our living environment. The general applications of light boxes include advertising boards, outdoor signboards, signage, and many others. Medical professionals, for example, also use light boxes for reading X-ray images.

Traditional light boxes are customarily manufactured after the requirements of their applications are determined, and the conventional custom manufacturing methods lack flexibility. Namely, if light boxes have different sizes or different aspect ratios, different light boxes may need different manufacturing tools to manufacture the components thereof.

When a large light box is prepared for manufacturing, the large light box cannot be manufactured by the conventional custom manufacturing methods to achieve uniform luminosity and good heat dissipation by merely adding more light sources therein without any modifications or redesign. In addition, if special requirements are needed for light boxes, specific mechanical components are required, increasing the total component number and complicating the assembly of the light boxes.

Light boxes used in different environments need to be manufactured following different specifications, which may have significantly different requirements from one another. Thus, the original design and manufacturing method for the light boxes need to be changed to meet different environmental requirements. For example, when an outdoor light box is designed and manufactured, the issues such as weather resistance and waterproofing should be considered; however, no consideration of such issues is required for an indoor light box. When the issues are considered, light boxes manufactured using the conventional custom manufacturing methods may need complicated mechanical components and may not be easily assembled.

In summary, traditional light boxes have the above-mentioned issues, and therefore a new light box without the issues is required.

### SUMMARY OF THE INVENTION

The present invention provides a light box apparatus, which uses metallic formed bars as its side frames, and thus it has good heat dissipation capability. The light box apparatus can be easily made of different sizes, and no new manufacturing tools are required. The light box apparatus of the present invention has a simple structure, which can achieve waterproofing, and therefore, it is suitable for installation in both indoor and outdoor environments. Moreover, a larger light box apparatus can be manufactured merely by adding more light sources for uniform light distribution, and no extra work is required.

The present invention provides a light box apparatus, which comprises at least one light source, a light guide plate, and a frame. The frame includes an accommodation space and side frames thereof trimmed from metallic formed bars. The light guide plate is received within the accommodation space and includes a lateral side. At least one of the side frames of the frame includes a first inlay groove adjacent to the lateral side of the light guide. The light source is received within the first inlay groove such that light emitted from the light source can pass through the lateral side and transmits in the light guide plate.

In one embodiment, at least one of the side frames of the light box apparatus comprises a second inlay groove, which is configured for insertion of a driving circuit board and power wires connecting the driving circuit board and the light source.

In one embodiment, at least one of the side frames of the light box apparatus comprises a third inlay groove for hoisting the frame.

In one embodiment, the light box apparatus further comprises a waterproof strip disposed between a transparent base plate and the support portions of the frame.

In one embodiment, the light box apparatus further comprises a waterproof strip disposed between a back plate and the plate fixing surface of the frame.

In one embodiment, in the frame, any two adjacent disposed side frames are connected with an end joint.

In one embodiment, the side frames are made from aluminum extruded bars.

### BRIEF DESCRIPTION OF THE DRAWINGS

The invention will be described according to the appended drawings in which:

FIG. 1 is a perspective view showing a light box apparatus according to one embodiment of the present invention;

FIG. 2 is a perspective view showing the frame of a light box apparatus according to one embodiment of the present invention;

FIG. 3 is an exploded perspective view showing the light box apparatus of FIG. 1;

FIG. 4 is a cross sectional view along line A-A of FIG. 1; and

FIGS. 5 and 6 are perspective views showing the waterproof structures of a light box apparatus according to one embodiment of the present invention.

### DETAILED DESCRIPTION OF THE INVENTION

The present invention provides a light box apparatus, which uses a plurality of metallic shaped bars as its side frames of its frame so as to improve the effectiveness of heat dissipation. The side frames of the light box of the present invention can be easily manufactured to have many varieties to meet different requirements. The side frames can be trimmed to different lengths according to requirements to simplify assembly of light box apparatuses having different sizes or different aspect ratios.

To manufacture a larger light box apparatus, only longer side frames and more side light sources are needed; the longer side frame does not require redesign and new tools for manufacturing the longer side frame are not necessary.

The light box apparatus of the present invention has a simple structure designed for waterproofing, and is suitable for installation in an outdoor environment.

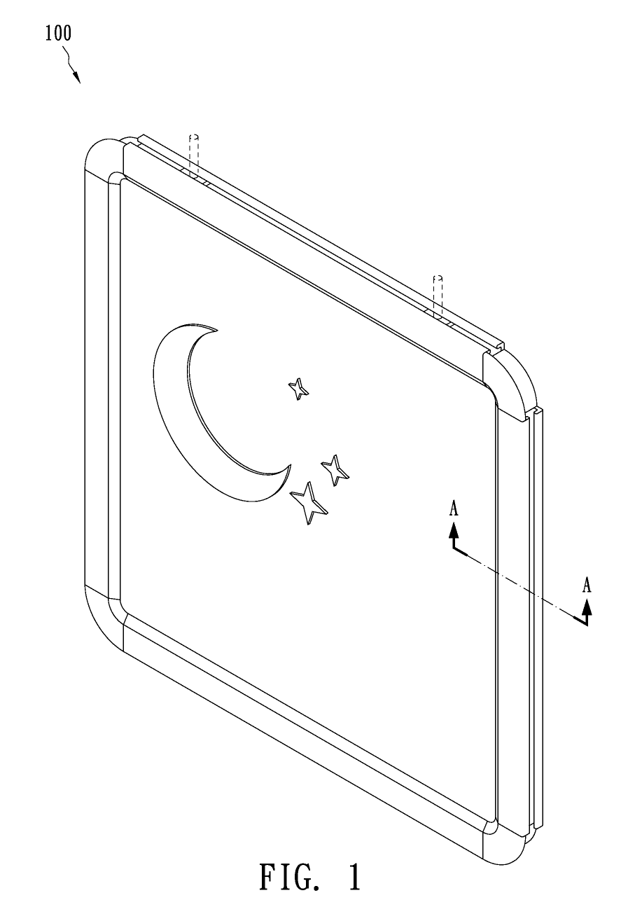

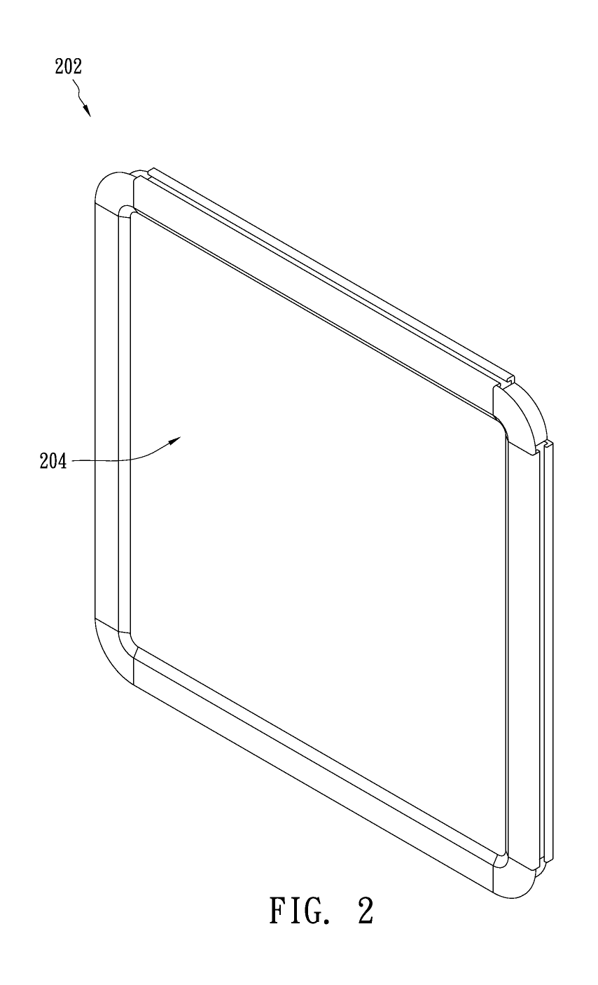

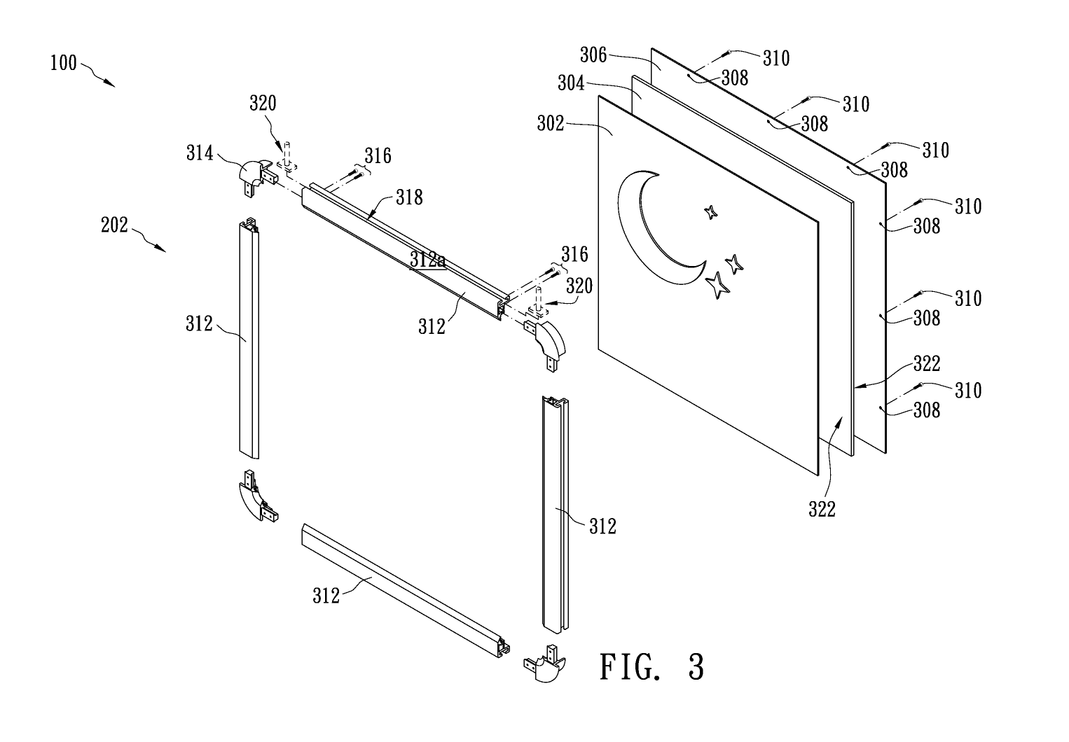

FIG. 1 is a perspective view showing a light box apparatus 100 according to one embodiment of the present invention, FIG. 2 is a perspective view showing the frame 202 of a light box apparatus 100 according to one embodiment of the present invention, and FIG. 3 is an exploded perspective view showing the light box apparatus 100 of FIG. 1. Referring to FIGS. 1 to 3, the light box apparatus 100 comprises a frame 202, a transparent base plate 302, a light guide plate 304, a back plate 306, a plurality of waterproof strips (not shown), a light source (not shown), and a driving circuit board (not shown) for powering the light source. The frame 202 comprises a plurality of side frames 312 and an accommodation space 204, which is enclosed by the plurality of side frames 312 and receives the transparent base plate 302 and the light guide plate 304 therein. The transparent base plate 302 is disposed on a light output surface at one side of the light guide plate 304, including pictures or text messages thereon for demonstration. The light guide plate 304 is for uniformly distributing light emitted from the light source (not shown) to the transparent base plate 302, wherein the light guide plate 304 can be made of acrylic. The back plate 306 is disposed on the light output surface at the other side, opposite to the transparent base plate 302, of the light guide plate 304, having a plurality of openings 308 for fixing. The transparent base plate 302 and the light guide plate 304 can be held in the frame 202 by fixing the back plate 306 to the frame 202 using fasteners 310 such as screws. The back plate 306 can be, for example, a zinc-coated steel plate.

Referring to FIG. 3, the frame 202 comprises a plurality of side frames 312 and a plurality of end joints 314 each for joining the respective two adjacent frame edge portions 312. Fasteners 316 such as screws can fasten the side frames 312 and the end joints 314. The upper side frame 312a of the frame 202 can include a third inlay groove 318 provided for a hanging member 320 for hoisting the light box apparatus 100. In one embodiment, the end joint 314 can be die cast. The side frames 312 are cut from metallic shaped bars, which can be aluminum extruded bars. In the present embodiment, the other side frames 312 and the upper side frame 312a can be fabricated from the same type of metallic shaped bars. The selected metallic shaped bars can be the metallic shaped bars having no exposed inlay grooves such as the third inlay groove 318 for the side frames 312. If the side frames 312 are from aluminum extruded bars, the cross sectional configurations thereof can be changed by changing the configuration of an aluminum extrusion die, which has a characteristic to produce products with diversified configurations, to meet the requirements to the side frames 312. Due to the ease of cutting aluminum extruded bars, the aluminum extruded bars can be easily cut into side frames 312 of different lengths for manufacturing of frames 202 having different sizes or different aspect ratios, and no new die is needed to meet the requirements of different sizes or different aspect ratios.

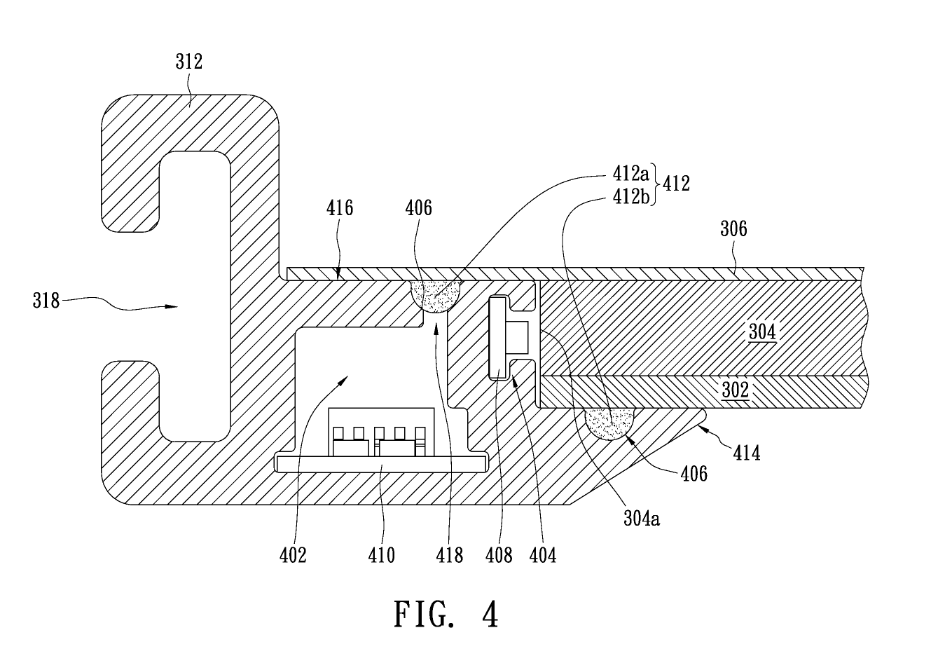

FIG. 4 is a cross sectional view along line A-A of FIG. 1. The side frame 312 further comprises a second inlay groove 402, a first inlay groove 404, and waterproof grooves 406. The first inlay groove 404 is adjacent to the lateral side 304a of the light guide plate 304, configured for receiving the light source 408. The light source 408 emits light passing through the lateral side 304a and transmitting in the light guide plate 304. The second inlay groove 402 is configured for receiving the driving circuit board 410 of the light source 408 and also for receiving the power wires (not shown) for connecting the light source 408 to the driving circuit board 410. In the present embodiment, the light source 408 can be a light emitting diode (LED) light bar, and a constant current can be supplied to the driving circuit board 410 to power the LED light bar. The adoption of the LED light bar not only saves power, but can also make the light box apparatus 100 smaller and lighter.

Referring to FIG. 4, each waterproof groove 406 is for receiving a waterproof strip 412 for inhibiting ingress of moisture so as to prevent the light source 408 and the driving circuit board 410 from malfunctioning or having an abnormal display. In one embodiment, the side frame 312 can be made of aluminum, and the aluminum side frame 312 help the light source 408 dissipate more heat. Moreover, when a large light box apparatus 100 is produced, light sources 408 can be added to the side frames 312 suitable to allow the light box apparatus 100 to generate uniformly distributed emission light. Thus, the technique for manufacturing a light box of the present invention provides better manufacturing flexibility compared with the prior art techniques.

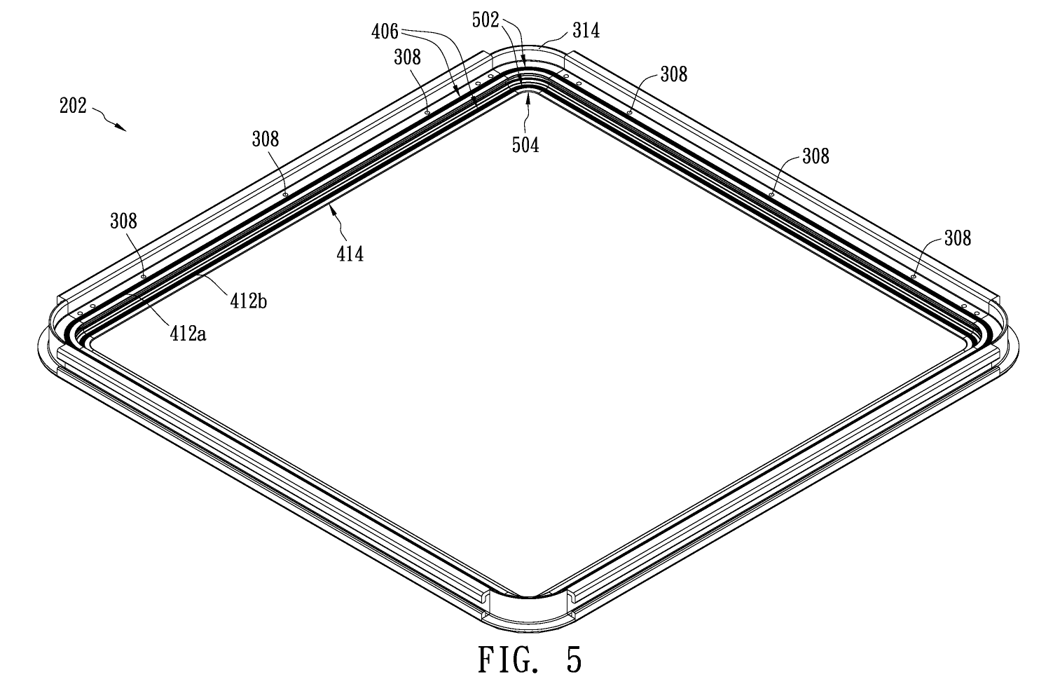

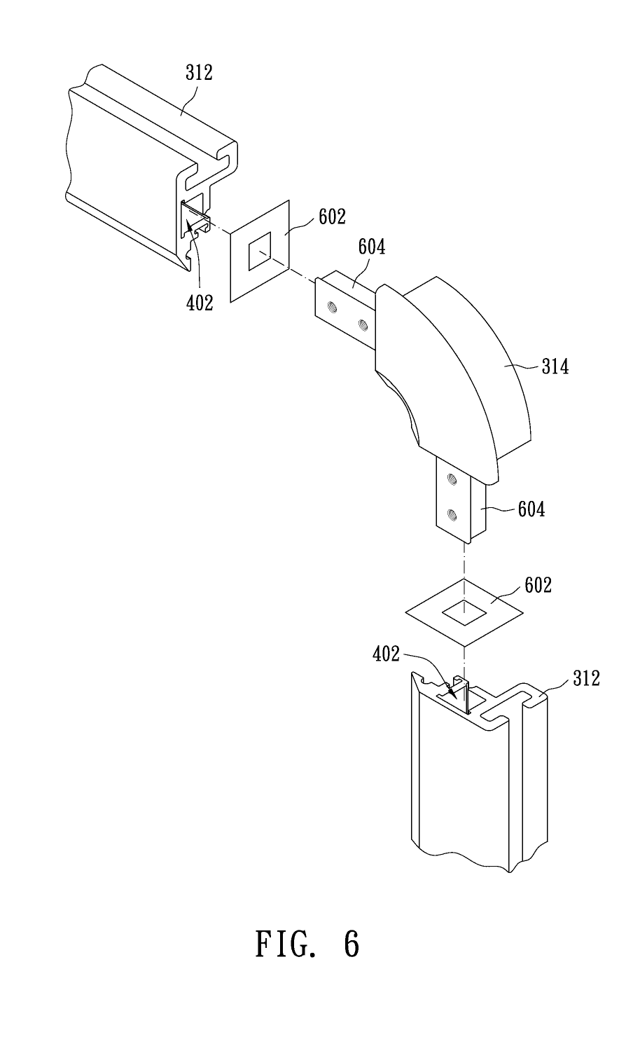

FIGS. 5 and 6 are perspective views showing the waterproof structures of a light box apparatus 100 according to one embodiment of the present invention. Referring to FIGS. 4 and 5, each end joint 314 includes waterproof grooves 502 disposed corresponding to the waterproof grooves 406 such that the waterproof strips 412a and 412b can be separately and surroundingly disposed on the frame 202. When the back plate 306 is fastened, the back plate 306 is pressed tightly against the waterproof strip 412a rested on the plate fixing surface 416 of the frame 202, and the transparent base plate 302 is pressed tightly against the waterproof strip 412b rested on the support portions 414 and 504 each extending from the respective side frame 312 toward the accommodation space 204 so that the light box apparatus 100 is waterproof. In the present embodiment, the waterproof strip 412a is inserted into the opening 418 of the waterproof groove 406, which is also the opening 418 of the second inlay groove 402, and the opening 418 is on the plate fixing surface 416. In summary, the light box apparatus 100 of the present invention has a simple structure and is waterproof so that it is suitable for installation both in indoor and outdoor environments.

Referring to FIG. 6, each end joint 314 comprises at least one convex portion 604, which is configured to be inserted into the respective second inlay groove 402 of the side frame 312. Such a connection design allows the frame 202 to be more easily assembled. Between each end joint 314 and the respective frame edge portions 312, waterproof mats 602 can be provided for sealing. As such, the seams between the mechanical components of the frame 202 can be water-sealed. In one embodiment, the waterproof strips (412a and 412b) and the waterproof mat 602 can be made of silicone gel.

In summary, the light box apparatus of the present invention has many advantages such that it has a simple structure; it can be easily manufactured to have different sizes or different aspect ratios; it can have more light sources to improve light uniformity; and it is waterproof, suitable for installation in indoor and outdoor environments.

The above-described embodiments of the present invention are intended to be illustrative only. Numerous alternative embodiments may be devised by persons skilled in the art without departing from the scope of the following claims.

What is claimed is:

1. A light box apparatus, comprising:
at least one light source;
a light guide plate including a lateral side adjacent to said light source; and
a frame including a plurality of side frames and an accommodation space surrounded by said plurality of side frames, wherein said light guide plate is received within said accommodation space;
wherein at least one said side frame has a first inlay groove adjacent to said lateral side of said light guide plate, and said light source is received within said first inlay groove, whereby light emitted from said light source can pass through said lateral side and transmit said light guide plate.

2. The light box apparatus as in claim 1, wherein said at least one side frame includes a second inlay groove for receiving a driving circuit board of said light source and power wires for connecting between said light source and said driving circuit board.

3. The light box apparatus as in claim 1, wherein said at least one frame edge portion includes a third inlay groove for hoisting said frame.

4. The light box apparatus as in claim 1, wherein said light box apparatus comprises a transparent base plate being disposed on a light output surface at one side of said light guide plate for displaying pictures or text messages.

5. The light box apparatus as in claim 4, wherein said light box apparatus comprises a first waterproof strip and said frame comprises a plurality of support portions, wherein said first waterproof strip is disposed between said transparent base plate and said support portions of said frame.

6. The light box apparatus as in claim 5, wherein said support portion extends from said respective side frame to said accommodation space.

7. The light box apparatus as in claim 5, wherein said support portion comprises a first waterproof groove for receiving said first waterproof strip.

8. The light box apparatus as in claim 4, wherein said light box apparatus comprises a back plate being disposed on a light output surface at the other side, opposite to said transparent base plate, of said light guide plate.

9. The light box apparatus as in claim 8, wherein said light box apparatus comprises a second waterproof strip being disposed between a plate fixing surface of said frame and said back plate.

10. The light box apparatus as in claim 9, wherein said second inlay groove further comprises an opening disposed on said plate fixing surface of said back plate, and said second waterproof strip seals on said opening of said second inlay groove.

11. The light box apparatus as in claim 1, wherein any two adjacent frame edge portions are joined by an end joint.

12. The light box apparatus as in claim 11, wherein said end joint comprises at least one convex portion and each frame edge portion comprises a second inlay groove, wherein said at least one convex portion of said end joint is configured to be inserted into the respective second inlay groove of said side frame.

13. The light box apparatus as in claim 11, wherein said light box apparatus comprises a waterproof mat disposed between said respective side frame and said respective end joint.

14. The light box apparatus as in claim 11, wherein said end joint is made by aluminum die cast method.

15. The light box apparatus as in claim 11, wherein said end joint comprises a second waterproof groove and said frame comprises a plurality of support portions each including a first waterproof groove, wherein said second waterproof groove is disposed corresponding to said first waterproof grooves.

16. The light box apparatus as in claim 1, wherein said light guide plate is made of acrylic.

17. The light box apparatus as in claim 1, wherein said plurality of side frames is made of aluminum.

18. The light box apparatus as in claim 2, wherein said light source is a light emitting diode (LED) light bar.

19. The light box apparatus as in claim 18, wherein a constant current is supplied to said driving circuit board to power said LED light bar.
